(19) United States
(12) Patent Application Publication
(10) Pub. No.: US 2014/0085458 A1
(43) Pub. Date: Mar. 27, 2014

(54) ANGULAR VISUAL RESPONSE OF COSMETIC SURFACES

(71) Applicant: APPLE INC., Cupertino, CA (US)

(72) Inventors: Adam D. FALK, San Jose, CA (US); Colin S. DUFFIE, Palo Alto, CA (US)

(73) Assignee: APPLE INC., Cupertino, CA (US)

(21) Appl. No.: 13/628,019

(22) Filed: Sep. 26, 2012

(51) Int. Cl. G01N 21/88; H04N 7/18

(52) U.S. Cl. CPC G01N 21/88; H04N 7/18
USPC 348/128; 356/73

(57) ABSTRACT

A system for determining the angular visual response of a cosmetic surface includes a sample support member configured to support a sample of material, a light detector arranged to travel along a first arcuate path about the sample of material, a light emitter arranged to travel along a second arcuate path about the sample of material, and an imaging device arranged to travel along a third arcuate path about the sample of material.

### FIELD OF THE DESCRIBED EMBODIMENTS

The described embodiments relate generally to cosmetic surfaces of products, and more particularly, to the angular visual response of cosmetic surfaces with one or more surface defects.

### BACKGROUND

Conventionally, surface treatments including colorization, coatings, sealants, and/or texturization may be used to promote relatively long-lasting cosmetic quality of a surface of a product, for example, such as a watch face or cellular phone display. The surface treatments may be configured to hide or obscure surface defects or to minimize their effects with regards to diminishing a cosmetic quality of a surface.

For example, surface sealants may be used to protect against scratches, nicks, and scrapes of an underlying surface. Colorization may be used to obscure scratches. Furthermore, texturization may be used to obscure debris, dirt, or fingerprints. However, an overall performance of these techniques may be measurable only with regards to the objectivity of an observer. The observer would, for example, observe the surface over time to determine a qualitative analysis of the overall performance of the treatment responsive to external factors, including wear, deposition of debris, application of fingerprints, and other factors. It should be readily understood that purely qualitative analysis of surface treatments may reduce a possibility of obtaining an optimal or near optimal treatment for any particular surface, and therefore, reduce a possibility of obtaining optimal or near optimal treatments for a large number of surfaces used in any particular product.

Therefore, what is needed are techniques for quantitative analysis of surfaces for the optimization of surface treatments that are repeatable for a variety of circumstances.

### SUMMARY OF THE DESCRIBED EMBODIMENTS

This paper describes various embodiments that relate to the angular visual response of cosmetic surfaces.

According to one embodiment of the invention, a system for determining the angular visual response of a cosmetic surface includes a sample support member configured to support a sample of material, a light detector arranged to travel along a first arcuate path about the sample of material, a light emitter arranged to travel along a second arcuate path about the sample of material, and an imaging device arranged to travel along a third arcuate path about the sample of material.

According to another embodiment of the invention, a system for determining the angular visual response of a cosmetic surface includes a support table, a sample support member arranged on the support table and configured to support a sample of material, a light detector arranged to detect light reflected off of the sample of material at a plurality of angles of observation, a light emitter arranged to emit light for reflection off of the sample of material at a plurality of angles of incidence, and an imaging device arranged to capture images of the sample of material at the plurality of angles of observation.

According to another embodiment of the invention, a system for determining the angular visual response of a cosmetic surface includes a support table, a sample support member arranged on the support table and configured to support a sample of material, a light source arranged proximate the support table and configured to generate light, a light emitter in optical communication with the light source and arranged to emit light for reflection off of the sample of material at a plurality of angles of incidence, a light detector arranged to detect light reflected off of the sample of material at a plurality of angles of observation, and an imaging device arranged to capture images of the sample of material at the plurality of angles of observation.

According to another embodiment of the invention, a system for determining the angular visual response of a cosmetic surface includes a support table, a sample support member arranged on the support table and configured to support a sample of material, a light detector arranged to travel about a first arcuate path about the sample of material, a light source arranged proximate the support table and configured to generate light, a light emitter in optical communication with the light source and arranged to emit the generated light and arranged to travel along a second arcuate path about the sample of material, and an imaging device arranged to travel about a third arcuate path about the sample of material.

Other aspects and advantages of the invention will become apparent from the following detailed description taken in conjunction with the accompanying drawings which illustrate, by way of example, the principles of the described embodiments.

### BRIEF DESCRIPTION OF THE DRAWINGS

Various aspects of this disclosure may be better understood upon reading the following detailed description and upon reference to the drawings in which:

FIG. 1 depicts a first perspective view of a product.

FIG. 2 depicts a second perspective view of a product.

FIG. 3 illustrates an angle of incidence and angle of observation of a cosmetic surface.

FIG. 4A depicts reflectivity of a cosmetic surface at a first angle of observation.

FIG. 4B depicts reflectivity of a cosmetic surface at a second angle of observation.

FIG. 5A is a schematic of a system for determining the angular visual response of a cosmetic surface, according to an embodiment of the invention.

FIG. 5B is a detailed schematic of one implementation of the system of FIG. 5A.

FIG. 6 is a flowchart of a method of obtaining spectrum reflectivity measurements of a cosmetic surface, according to an embodiment of the invention.

FIG. 7 is a flowchart of a method of quantitative analysis of the angular visual response of a cosmetic surface, according to an embodiment of the invention.

FIG. 8 is a flowchart of a method of determining a quantitative performance metric for a cosmetic surface, according to an embodiment of the invention.

FIG. 9 is a flowchart of a method of automated optimization of a cosmetic surface for a product based on a performance metric, according to an embodiment of the invention.

FIGS. 10-16 depict a plurality of plots of experimental results of analysis of a plurality of samples as follows:

FIG. 10 is a contour plot of reflectance of a first sample.

FIG. 11 is a contour plot of a reflectance of the first sample with an introduced cosmetic defect.

FIG. 12 is a contour plot of the color flop associated with the cosmetic defect of the first sample.

FIG. 13 is a contour plot of the color flop associated with a cosmetic defect of a fifth sample.

FIG. 14 is a plot of luminosity difference between each of the plurality of samples.

FIG. 15 is a plot of L*a*b* Colorspace versus Angle of Observation of another sample.

FIG. 16 is an expanded portion of the plot of FIG. 15.

FIG. 17 is a schematic of a controller, according to an embodiment of the invention.

### DETAILED DESCRIPTION OF SELECTED EMBODIMENTS

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

Embodiments of the invention provide quantitative technique of evaluating the light reflective properties of cosmetic surfaces at various angles. These techniques allow for tuning and changing of surface treatments to minimize effects of fingerprints, wear, and other surface defects from being noticeable to customers. The quantitative aspect of the described examples may be further enhanced through qualitative analysis of images taken in conjunction with the quantitative measure of the light reflective properties, for example, through use of an image capture device positioned relative to quantitative measuring devices. Therefore, embodiments of the invention may provide for reduced subjectivity during evaluation of several iterations of surface treatments for a variety of products.

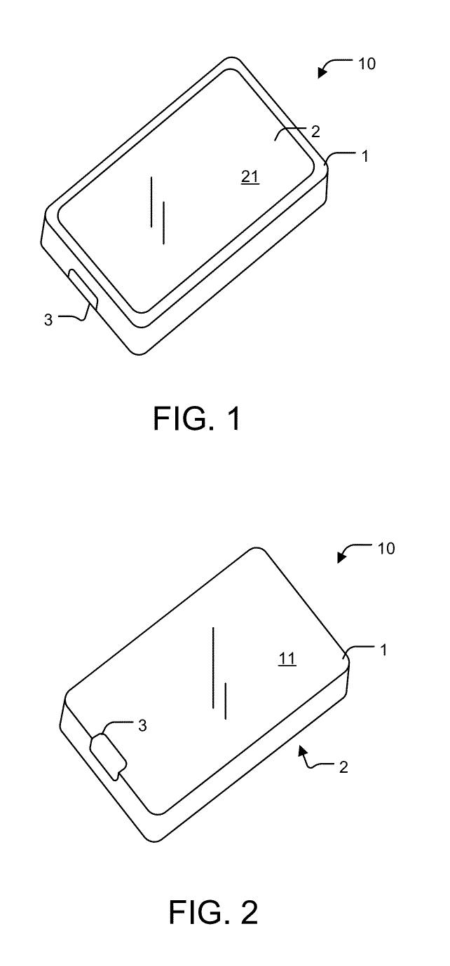

Turning to FIG. 1, a first perspective view of a product 10 is illustrated. As shown, the product 10 may be an end-user product including cellular telephone or personal electronic device such as, for example, a tablet computer, laptop computer, or other device. The product 10 may include a display or interface area 2 comprising a cosmetic surface 21 subject to user interaction through touch. The product 10 may further include a housing 1 formed of aluminum or other suitable materials that may be subject to fingerprints or wear of surfaces thereon. The product 10 may further include cosmetic cap/antenna window 3 which may be subject to wear. Furthermore, area 2, housing 1, and cap 3 may be formed of different materials, and therefore may require a variety of surface treatments.

Turning to FIG. 2, a second perspective view of the product 10 is provided. As shown, the product 10 includes additional cosmetic surface 11 which may be subject to fingerprints, wear, and/or other surface defects.

As such, a plurality of materials and surface treatments may be considered for producing the product 10. However, given the subjective nature of conventional analysis techniques, it may be difficult to automate a more quantitative analysis of a plurality of materials and surface treatments to determine an optimal or somewhat optimal form of material and surface treatment. Furthermore, reflective properties of materials may depend upon an angle of incidence of light and an angle of observation.

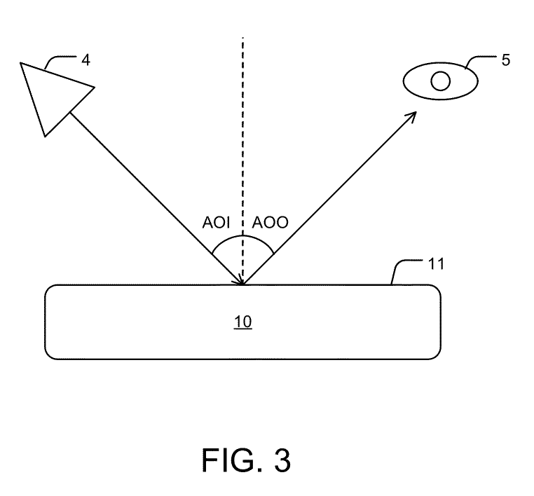

For example, FIG. 3 illustrates an angle of incidence (AOI) and angle of observation (AOO) of a cosmetic surface 11 of the product 10. As shown, the light source 4 may emit light which partially reflects off of surface 11 to reach an observer 5. Depending upon both the AOI and the AOO, the observer 5 may receive a different spectrum of light representative of the physical properties of the surface 11 and any surface defects thereon.

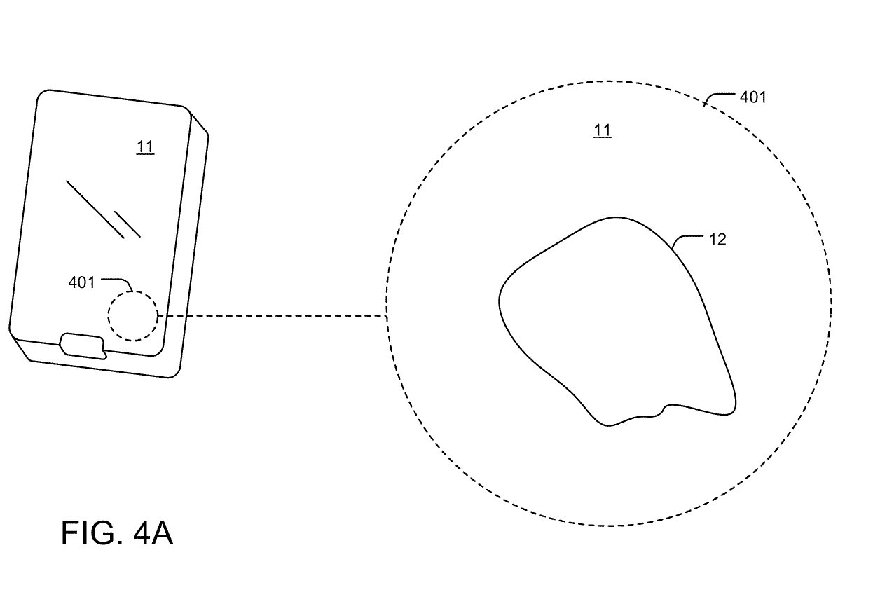

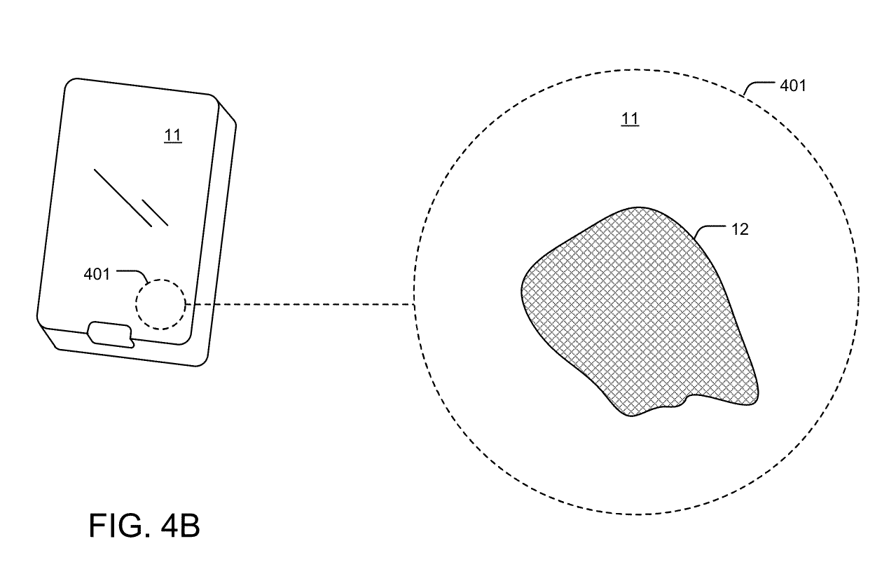

FIG. 4A depicts reflectivity of cosmetic surface 11 at a first angle of observation and FIG. 4B depicts reflectivity of the cosmetic surface 11 at a second angle of observation. As shown in expanded view 401, a cosmetic defect 12 may only be partially noticeable to the observer at the first angle of observation of FIG. 4A. However, turning to FIG. 4B, the spectrum reflected may change due to the change in the angle of observation which may make the surface defect 12 more noticeable. As such, the particular material comprising the cosmetic surface 11 may be tuned through the teachings provided herein to reduce the spectrum reflectivity changes to promote obscuring or hiding of surface defects. This may be implemented through a system for determining the angular visual response of a plurality of sample materials with a plurality of surface treatments.

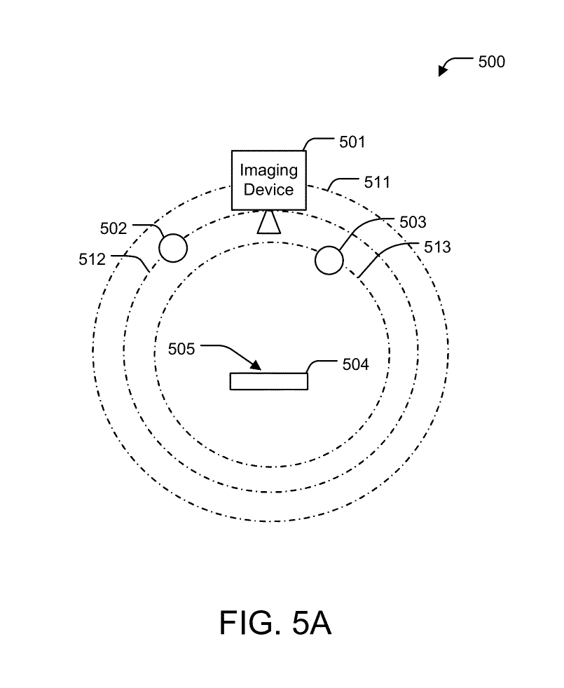

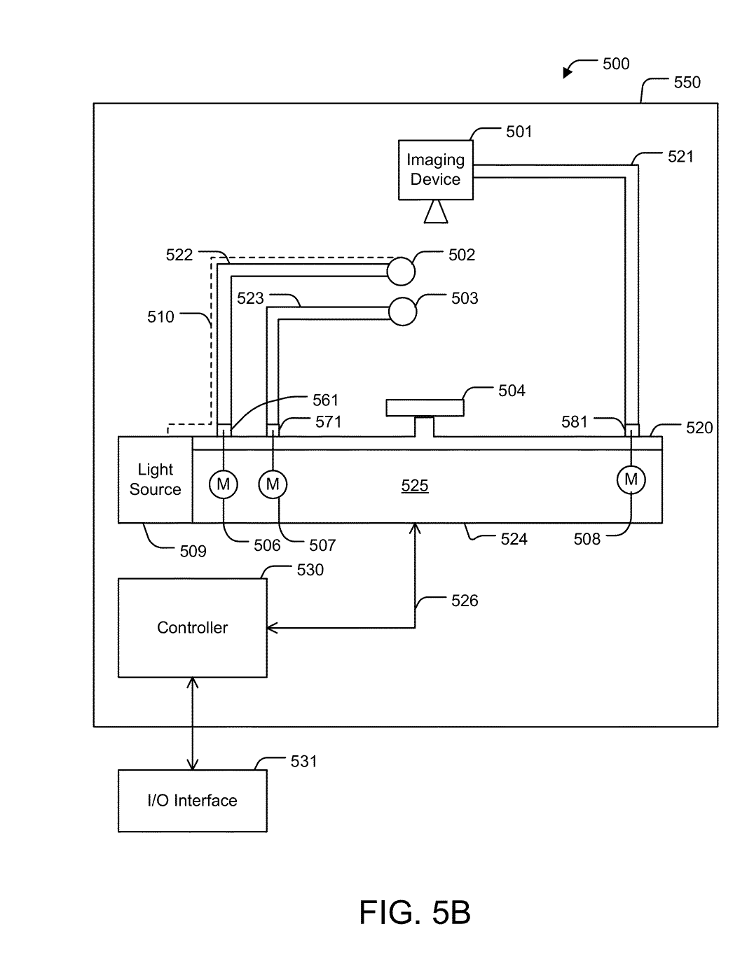

FIG. 5A is a schematic of a system for determining the angular visual response of a cosmetic surface, according to an embodiment of the invention. As illustrated, the system 500 includes sample support member 504 for supporting a sample 505. The sample support member 504 may be any suitable member, including a tray, table, or relatively stable structure for fixedly retaining the sample 505 during angular visual response determination processes and methods.

The system 500 further includes a light detector 503 arranged to travel along a first arcuate path 513. The first arcuate path 513 may be a generally circular path such that the light detector 503 may be arranged at a plurality of angles of observation relative to the sample 505. According to one embodiment, the light detector 503 is a spectrometer configured to receive light and determine a magnitude of a plurality of spectrum components of the received light. The spectrum components may include components in the visible light spectrum as well as other components including ultraviolet and infrared components.

The system 500 further includes a light emitter 502 arranged to travel along a second arcuate path 512. The second arcuate path 513 may be a generally circular path such that the light emitter 502 may be arranged at a plurality of angles of incidence relative to the sample 505. According to one embodiment, the light emitter 502 includes at least one emitter configured to emit collimated light. According to one embodiment, the light emitter 502 includes at least two emitters, with a first emitter configured to emit collimated light and a second emitter configured to emit diffuse light. Other alternative implementations may also be applicable, including emission of coherent or LASER light for determination of surface reflectivity.

The system 500 further includes an imaging device 501 arranged to travel along a third arcuate path 511. The third arcuate path 511 may be a generally circular path such that the imaging device 501 may be arranged at a plurality of angles of observation relative to the sample 505. According to one embodiment, the imaging device includes a lens assembly and an image sensor configured to capture an image of a surface of the sample 505. According to one embodiment, the imaging device 501 is a camera device.

The first, second, and third arcuate paths 513, 512, and 511 may exist on planes parallel to one another in some embodiments, for example, to promote repeatability of observable spectrum reflections for a plurality of different samples. The first, second, and third arcuate paths 513, 512, and 511 may be adjustable, for example, through expansion or reduction in a radial distance from the sample 505. Furthermore, the first, second, and third arcuate paths 513, 512, and 511 may be co-planar in some embodiments, of may be offset in other embodiments.

As shown, light may be emitted from emitter 502 and received at detector 503 for a plurality of angles of incidence and observation. Furthermore, imaging device 501 may be positioned at a plurality of angles of observation such that images representative of spectrum measurements noted above may also be captured. Hereinafter, a more detailed explanation of one possible implementation of the system 500 is presented with reference to FIG. 5B. It is noted that other alternative implementations are also possible, and therefore, the particular form described below is non-limiting of all embodiments of the invention.

FIG. 5B is a schematic of one implementation of the system 500 of FIG. 5A. As shown, the detector 503 may be supported with a first support member 523. The first support member 523 may be a generally angular member having a vertical member and a horizontal member. The vertical member may be coupled to axial bearing 571 allowing for travel of the detector 503 along the first arcuate path illustrated in FIG. 5A. Axial bearing 571 may be any suitable bearing, including a bearing coupled to a motor 507 allowing for automated movement of the detector 503. The axial bearing 571 may be supported through support table 520, for example, through attachment with one or more fasteners.

As further shown, the emitter 502 may be supported with a second support member 522. The second support member 522 may be a generally angular member having a vertical member and a horizontal member. The vertical member may be coupled to axial bearing 561 allowing for travel of the emitter 502 along the second arcuate path illustrated in FIG. 5A. Axial bearing 561 may be any suitable bearing, including a bearing coupled to a motor 506 allowing for automated movement of the emitter 502. The axial bearing 561 may be supported through support table 520, for example, through attachment with one or more fasteners.

As further shown, the emitter 502 may be coupled to light source 509 through one of more optical waveguides 510. The optical waveguides 510 may be optical fibers, and may be configured to transmit light from the light source 509 to the emitter 502. According to one embodiment, the optical waveguides 510 include at least one optical fiber configured to transmit collimated light to the emitter 502. According to one embodiment, the optical waveguides 510 include at least two optical fibers, with a first optical fiber configured to transmit collimated light to a first emitter of emitter 502, and a second optical fiber configured to transmit diffuse light to a second emitter of emitter 502. The light source 509 may be any suitable light source, including a light bulb, LASER source, light emitting diode or diodes, and/or any other suitable device. Furthermore, according to one embodiment, the light source 509 is relatively high-wattage halogen light bulb configured to produce light of a similar spectrum to natural daylight. Thus, spectrum measurements from the detector 503 may be used to model and translate reflective properties of a sample under observation into observations for any light source through transformation of spectrum values based on a model for a particular light source.

As further shown, the imaging device 501 may be supported with a third support member 521. The second support member 521 may be a generally angular member having a vertical member and a horizontal member. The vertical member may be coupled to axial bearing 581 allowing for travel of the imaging device 501 along the third arcuate path illustrated in FIG. 5A. Axial bearing 581 may be any suitable bearing, including a bearing coupled to a motor 508 allowing for automated movement of the imaging device 501. The axial bearing 581 may be supported through support table 520, for example, through attachment with one or more fasteners.

Motors 506, 507, and 508 may be disposed within a mechanical cavity 525 defined by housing 524, which is disposed proximate support table 520. Alternatively, motors 506, 507, and 508 may be arranged differently. According to one embodiment, motors 506, 507, and 508 are servomotors with a clutch or braking mechanism allowing for stable movement of associated support members 521, 522, and 523.

As further shown, an outer shroud 550 may shield the components described above from ambient light during execution of one or more of the methods described herein. Shroud 550 may be any suitable shroud, including an at least partially pivoting shroud allowing for access to member 504 for placement of a sample for testing. Shroud 550 may be omitted in some implementations.

As further shown, a controller 530 may be in communication with one or more of the components described above through communication channels 526. An I/O interface 531 may further be provided, for example, for manipulation of computer executable instructions for execution through controller 530. Communication channels 526 may include any suitable channels, including channels arranged to control motors, control light emission and detection, position and re-position components 501, 502, and 503, and/or any other suitable channels.

Although not particularly illustrated, it should be understood that other components may be arranged or included in system 500 according to any desired implementation of the system illustrated in FIG. 5A. Furthermore, components may differ from those particularly illustrated, and therefore, those components described herein and any suitable or desirable equivalents should also be considered to be within the scope of some embodiments of the invention.

As described above, systems for evaluating the light reflective properties of cosmetic surfaces at various angles are provided which include light detectors, imaging devices, and light emitters which are arranged to travel along arcuate paths about a sample under observation. The plurality of available positions allows for quantitative analysis of samples as described below alongside qualitative analysis of images captured through an imaging device. The quantitative analysis may aid in reducing a sample pool of materials for time consuming and subjective qualitative evaluation.

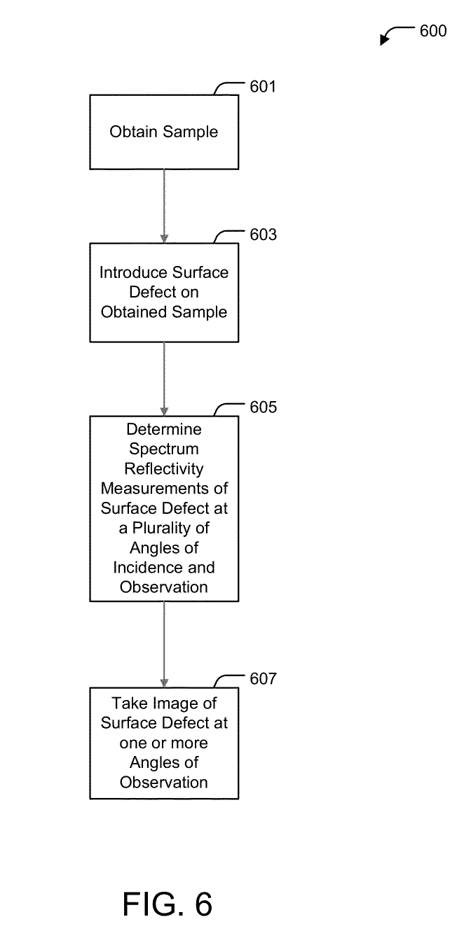

FIG. 6 is a flowchart of a method 600 of obtaining spectrum reflectivity measurements of a cosmetic surface, according to an embodiment of the invention. The method 600 includes obtaining a sample at block 601. For example, the sample may be obtained from a pool of samples, and may include at least one cosmetic surface for observation. The cosmetic surface may include a surface treatment, including but not limited to, anodization, texturization, sealing, colorizing, pigmenting, or other suitable treatments. The sample may be embodied as a piece or fragment of material, or may include a fully or partially assembled product.

The method 600 further includes introducing a surface defect on the at least one cosmetic surface of the obtained sample at block 603. This step may be omitted if first determining spectrum reflectivity of a sample without a cosmetic defect. Introducing the cosmetic defect may include intentionally applying a fingerprint, depositing dirt, grime, oil, or other contaminants, wearing away a portion of the surface, polishing portion of the surface, scratching or denting the surface, or any other changes to the surface. According to one embodiment, introducing the surface defect includes applying thin, measurable quantity of sebum (either artificial or natural) to the cosmetic surface (e.g., an artificial but controlled fingerprint). According to one embodiment, introducing the surface defect includes controllably wearing the surface using a repeatable process. According to one embodiment, introducing the surface defect includes applying thin, measurable quantity of dust to the cosmetic surface (e.g., to simulate a dusty environment or carrying within a pocket). Other forms of introducing surface defects are also applicable in any desired implementation of embodiments of the invention.

The method 600 further includes determining spectrum reflectivity measurements of the surface defect at a plurality of angles of incidence and observation at block 605. The spectrum reflectivity measurements may be facilitated through a system somewhat similar to the system of FIG. 5A or 5B, and may include positioning a light emitter at a plurality of angles of incidence and a light detector at a plurality of angles of observation. The light detector may measure spectrum components of the reflected light and determine associated magnitudes for quantitative analysis.

The method 600 further includes capturing images of the surface defect at the plurality of angles of observation at block 607. For example, the images may be captured at the same angles of observation as the spectrum measurements of block 605. In this manner, a qualitative or subjective analysis of the sample may be performed to aid in evaluation of the quantitative analysis.

Generally, a plurality of samples may be observed using the method 600, and a plurality of spectrum measurements may be obtained alongside images related to the reflectivity at one or more angles of observation. Thereafter, quantitative analysis may occur such that an overall evaluation of sample materials may be obtained.

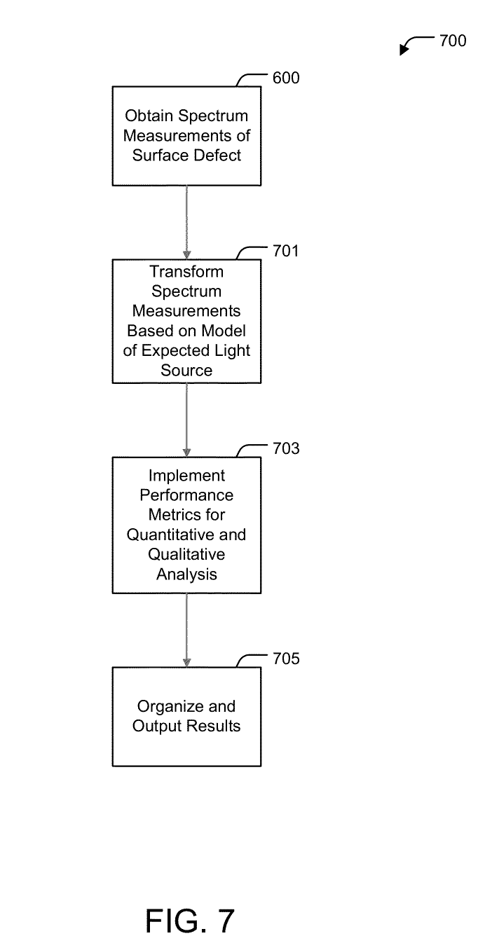

FIG. 7 is a flowchart of a method 700 of quantitative analysis of the angular visual response of a cosmetic surface, according to an embodiment of the invention. The method 700 includes performing the method 600 to obtain spectrum measurements of a surface defect for one or more samples.

The method 700 further includes transforming the spectrum measurements based on a predetermined model of an expected light source at block 701. For example, the expected light source may be a source of light during which typical observation of a final product would likely occur. For example, a tablet computer may be used both indoors and outdoors, therefore, an expected light source may include natural sun light as well as household light bulbs of a plurality of forms. As such, spectrum measurements may be transformed using the typical daylight spectrum as well as the typical spectrum for indoor lighting. Other scenarios are equally applicable, and therefore exhaustive description of every possible expected light source is omitted herein for the sake of brevity.

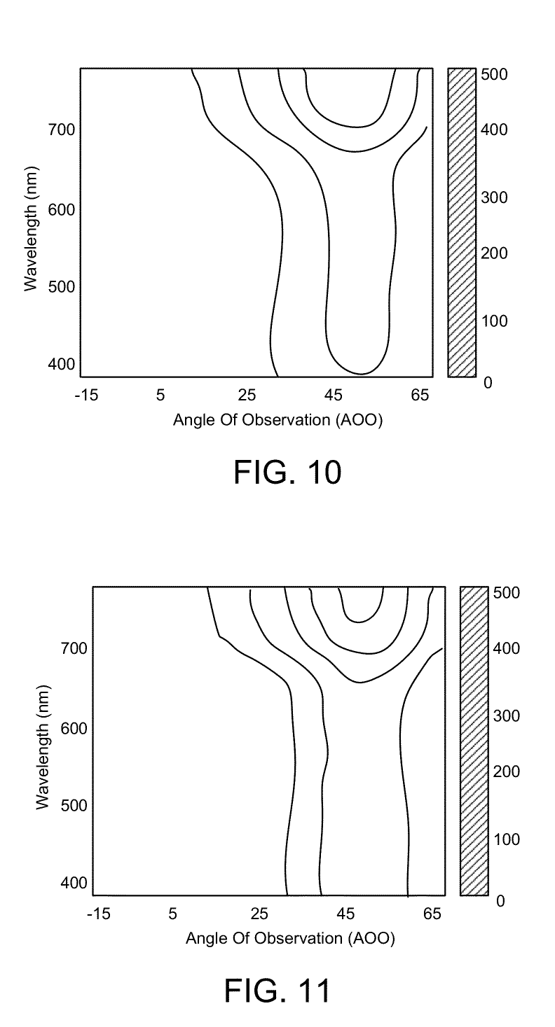

The method 700 further includes implementing performance metrics for quantitative and qualitative analysis at block 703. Performance metrics may include a plurality of metrics of reflectivity, including color change, color flop, luminosity, difference in luminosity, and other suitable metrics based on initial samples without surface defects and subsequent introduced surface defects. The implementing performance metrics may include translating the transformed spectrum measurements into meaningful output such as contour plots and comparative graphs based on a pool of samples. This is described more fully below with reference to FIGS. 10-16. Thereafter, the results of the implementing may be organized and output for qualitative analysis at block 705.

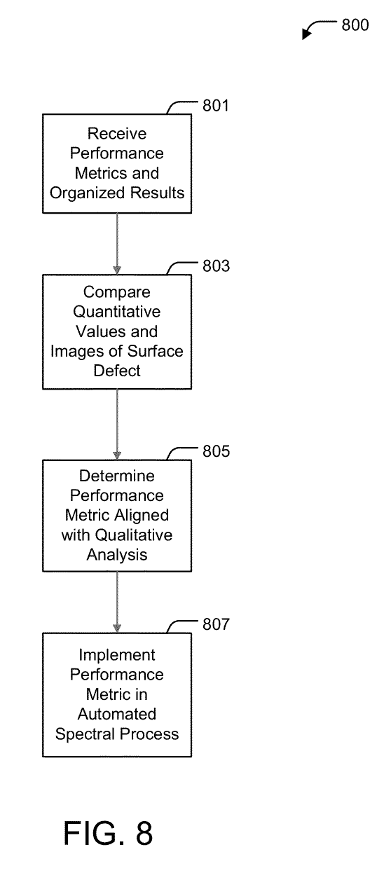

The qualitative analysis may include observing images and associated spectrum measurements to determine an accurate performance metric which relatively closely conveys cosmetic surface quality to reduce human error. The accurate performance metric may include more than one performance metric, and may be based on a plurality of spectrum measurements. For example, FIG. 8 is a flowchart of a method 800 of determining a quantitative performance metric for a cosmetic surface, according to an embodiment of the invention.

The method 800 includes receiving performance metrics and organized results of a quantitative analysis at block 801. The receiving may be facilitated through execution of the method 700. Thereafter, the method 800 includes comparing the organized quantitative values and associated images of a surface defect at block 803. The comparing may include comparing a quantitative value of cosmetic surface quality (e.g., ability to obscure fingerprints or hide scratches) to one or more images of the surface defect.

The method 800 further includes determining one or more performance metrics aligned with the qualitative analysis at block 805. For example, the determining may include determining which performance metric or metrics more closely convey the qualitative opinion of the observer of cosmetic quality of the sample. The qualitative opinion may include a subjective analysis of images of the samples to determine which samples had a better or worse cosmetic quality, and a comparison to the plurality of quantitative values to determine which concluded similar results.

Thereafter, the method 800 includes implementing the one or more determined performance metrics in an automated spectral reflectivity process at block 807.

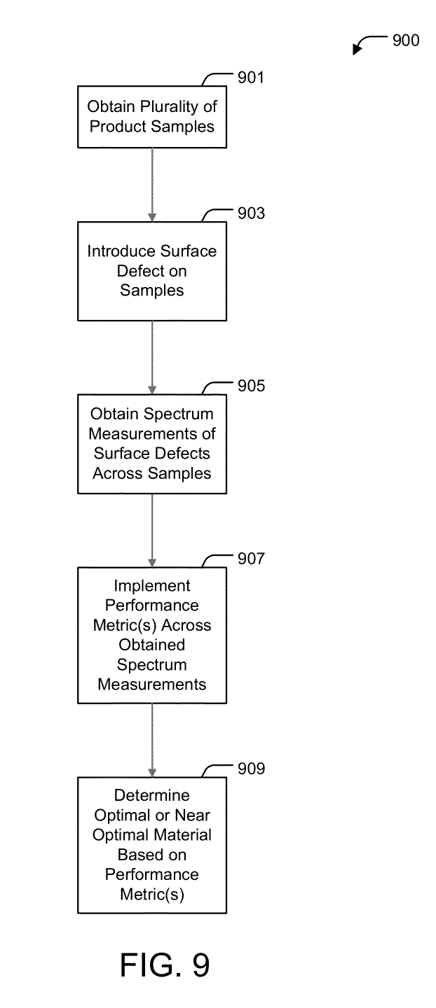

For example, FIG. 9 is a flowchart of a method 800 of automated optimization of a cosmetic surface for a product based on a performance metric, according to an embodiment of the invention. The method 900 includes obtaining a plurality of product samples at block 901. The samples may be obtained from a pool of samples, and each sample may include at least one cosmetic surface for observation. The cosmetic surface may include a surface treatment, including but not limited to, anodization, texturization, sealing, colorizing, pigmenting, or other suitable treatments. The samples may be embodied as pieces or fragments of material, or may include a fully or partially assembled product.

The method 900 further includes introducing surface defects on the cosmetic surfaces of the samples at block 903. Introduction of surface defects may include processes similar to those described above with reference to method 600.

The method 900 further includes obtaining spectrum measurements of surface defects across the plurality of samples at block 907. Obtaining spectrum measurements may include processes similar to those described above with reference to method 600, for example, by positioning and re-positioning light emitters, detectors, and imaging devices about a plurality of angles of incidence and observation for each sample.

The method 900 further includes implementing one or more performance metrics across the obtained spectrum measurements at block 907. The one or more performance metrics may include any metrics described herein, including color flop, luminosity, difference in luminosity, and other metrics not herein defined. The one or more performance metrics may be chosen with a method similar to method 800, for example, through determination of one or more performance metrics that convey cosmetic surface qualities relatively accurately.

The method 900 further includes determining an optimal or near optimal material based on the performance metric or metrics. The optimal or near optimal material may be chosen from the samples based on comparison between associated performance metrics. The optimal or near optimal material may be suitably of high cosmetic quality under an intended condition (e.g., obscuring fingerprints) while not under some circumstances (e.g., not good at obscuring scratches), and may be a material with balanced features depending upon any desired implementation.

The method 900 may be performed for a plurality of samples as noted, and may further include qualitative analysis of a plurality of samples near or within a threshold value of the one or more performance metrics. In this manner, human error in product cosmetic quality analysis may be reduced and a large or relatively large number of sample surfaces may be processed in an automated and fast manner.

As noted above, a plurality of performance metrics may be considered to determine an appropriate metric for one or more aspects of cosmetic surface quality. FIGS. 10-16 depict a plurality of plots of experimental results of analysis of a plurality of samples as follows

FIG. 10 is a contour plot of reflectance of a first sample and FIG. 11 is a contour plot of a reflectance of the first sample with an introduced cosmetic defect. As illustrated, the cosmetic defect is clearly measureable about a plurality of angles of observation near 45 degrees and in wavelengths of light above about 650 nanometers. Therefore, quantitative analysis using reflectance as an initial metric may be feasible for this particular form of surface defect. As such, other performance metrics across multiple samples using reflectance and measurements based on reflectance may be suitable in reducing a pool of samples for human observation and qualitative analysis.

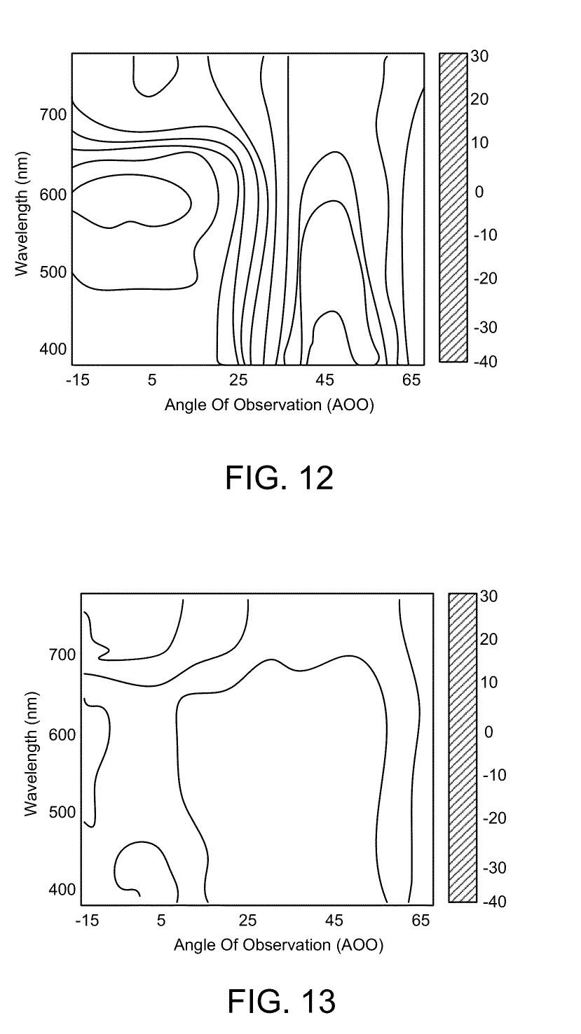

FIG. 12 is a contour plot of the color flop associated with the cosmetic defect of the first sample. The contour plot depicts the difference in reflectance between FIG. 10 and FIG. 11 through application of Equation 1 provided below:

Percent Difference of Reflectance=(R₁−R₀)/R₀ Equation 1

In Equation 1, R₀ represents measurements of the first sample without the introduced cosmetic defect and R₁ represents measurements of the first sample with the introduced cosmetic defect. As illustrated in FIG. 12, color flop is clearly observable about 45 degrees in observation, and therefore, sample 1 may not be a suitable material for uses subject to the cosmetic defect introduced in this example.

FIG. 13 is a contour plot of the color flop associated with a cosmetic defect of a fifth sample. As shown, color flop associated with this fifth sample is not as clear an issue as compared to the first sample, and therefore, the fifth sample may be more suitable for uses subject to this particular form of surface defect.

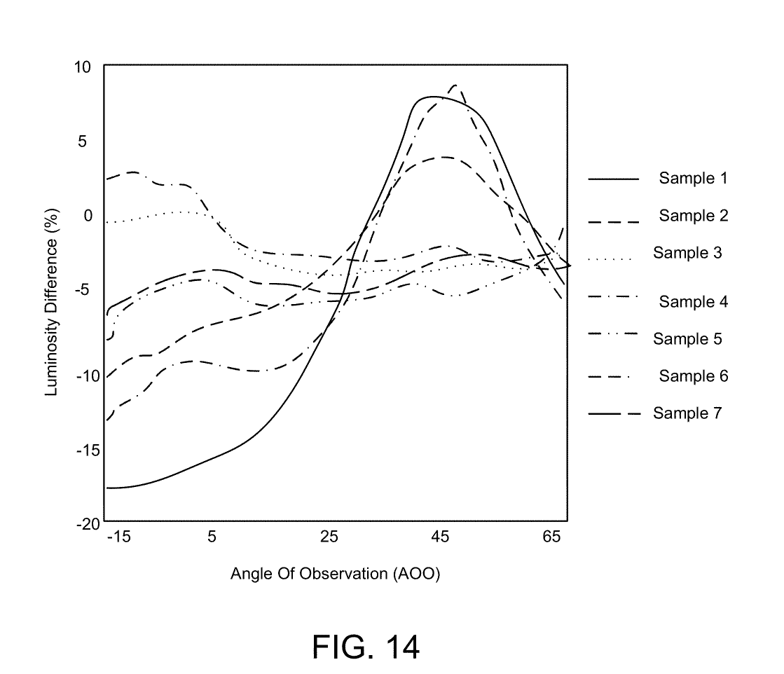

FIG. 14 is a plot of luminosity difference between each of the plurality of samples subjected to the particular surface defect analyzed for this set of experimental results. The luminosity difference may be calculated using Equation 2 reproduced below:

Luminosity Difference=(L*₁−L*₀)/L*₀ Equation 2

In Equation 2, L*₀ represents the luminosity measured according to the CIELAB colorspace (e.g., L*, a*, b*) of a sample without the introduced cosmetic defect and L*₁ represents luminosity of the sample with the introduced cosmetic defect. The disparity between peaks and valleys of the luminosity difference for each of the example samples is tabulated in Table 1, below:

TABLE 1

| Sample | Luminosity Difference |
|---|---|
| Sample 1 | 26.4 |
| Sample 2 | 14.9 |
| Sample 3 | 4.4 |
| Sample 4 | 6.3 |
| Sample 5 | 7.5 |
| Sample 6 | 22.4 |
| Sample 7 | 3.9 |

As shown above, Sample 3 and Sample 7 include the least difference in luminosity and therefore may be suitable in uses subject to the particular surface defect introduced. Furthermore, images of each of the samples may be included to aid in further qualitative analysis of each of the samples to determine alignment between qualitative and quantitative analyses. Moreover, further performance metrics may be implemented, considered, and automated to aid in reducing a pool of samples for further human observation and evaluation.

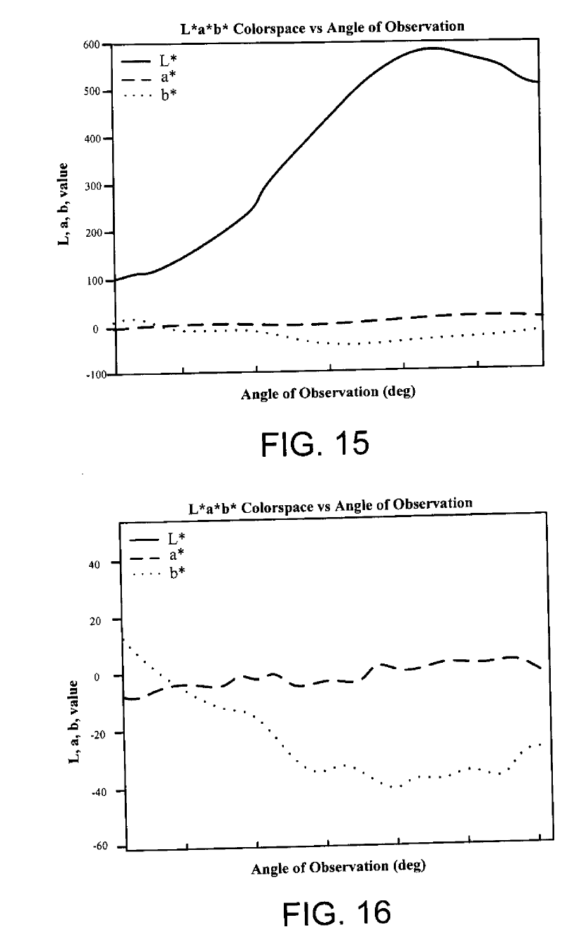

For example, FIG. 15 is a plot of L*a*b* Colorspace versus Angle of Observation of another sample and FIG. 16 is an expanded portion of the plot of FIG. 15. Such additional performance metrics may also be considered for any pool of samples under automated observation to aid in determining appropriate materials for further observation and testing.

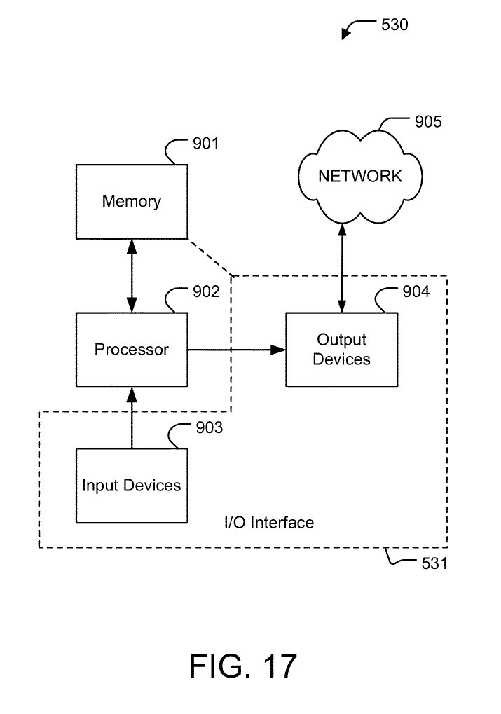

As described above, methods of quantitative analysis of cosmetic surface quality of a plurality of material samples may be used to reduce a pool of samples for qualitative analysis, and may therefore aid in reducing human error and subjectivity of the qualitative analyses. The methods may be automated using a system somewhat similar to system 500, for example, through implementation as software and/or computer-executable instructions for execution with a controller. FIG. 17 is a schematic of a controller, according to an embodiment of the invention. As illustrated, the controller 530 may be networked through network 905, and may include a memory 901, processor 902, input devices 903 and output device 904.

Furthermore, various aspects of the described embodiments can be implemented by software, hardware or a combination of hardware and software. The described embodiments can also be embodied as computer readable code on a computer readable medium for controlling inspection operations or as computer readable code on a computer readable medium for controlling a manufacturing line or inspection line. The computer readable medium is any data storage device that can store data which can thereafter be read by a computer system. Examples of the computer readable medium include read-only memory, random-access memory, CD-ROMs, HDDs, DVDs, magnetic tape, and optical data storage devices. The computer readable medium can also be distributed over network-coupled computer systems so that the computer readable code is stored and executed in a distributed fashion.

Moreover, various aspects of the described embodiments can be used separately or in combination.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A system for determining the angular visual response of a cosmetic surface, comprising:
a sample support member configured to support a sample of material;
a light detector arranged to travel along a first arcuate path about the sample of material;
a light emitter arranged to travel along a second arcuate path about the sample of material; and
an imaging device arranged to travel along a third arcuate path about the sample of material.

2. The system of claim 1, wherein the sample support member is configured to fixedly retain the sample of material during angular visual response measurement.

3. The system of claim 1, wherein the light detector includes a spectrometer configured to measure magnitudes of spectrum components of light reflected off of the sample of material at a plurality of angles of observation.

4. The system of claim 3, wherein the first arcuate path defines the plurality of angles of observation.

5. The system of claim 3, wherein the imaging device is configured to capture images of the sample of material at each of the plurality of angles of observation.

6. The system of claim 1, wherein the light emitter includes at least one emitter configured to emit collimated light for reflection off of the sample of material at a plurality of angles of incidence.

7. The system of claim 6, wherein the second arcuate path defines the plurality of angles of incidence.

8. The system of claim 1, wherein the light emitter includes at least two emitters, and wherein:
a first emitter of the at least two emitters is configured to emit collimated light; and
a second emitter of the at least two emitter is configured to emit diffuse light.

9. A system for determining the angular visual response of a cosmetic surface, comprising:
a support table;
a sample support member arranged on the support table and configured to support a sample of material;
a light detector arranged to detect light reflected off of the sample of material at a plurality of angles of observation;
a light emitter arranged to emit light for reflection off of the sample of material at a plurality of angles of incidence; and
an imaging device arranged to capture images of the sample of material at the plurality of angles of observation.

10. The system of claim 9, wherein the light detector is further arranged to travel along a first arcuate path about the sample of material.

11. The system of 9, wherein the light detector includes a spectrometer configured to measure magnitudes of spectrum components of light.

12. The system of claim 9, wherein the light emitter is further arranged to travel along a second arcuate path about the sample of material.

13. The system of claim 9, wherein the light emitter includes at least one emitter configured to emit collimated light for reflection off of the sample of material.

14. The system of claim 9, wherein the light emitter includes at least two emitters, and wherein:
a first emitter of the at least two emitters is configured to emit collimated light; and
a second emitter of the at least two emitter is configured to emit diffuse light.

15. The system of claim 9, wherein the imaging device is further arranged to travel along a third arcuate path about the sample of material.

16. A system for determining the angular visual response of a cosmetic surface, comprising:
a support table;
a sample support member arranged on the support table and configured to support a sample of material;
a light source arranged proximate the support table and configured to generate light;
a light emitter in optical communication with the light source and arranged to emit the generated light for reflection off of the sample of material at a plurality of angles of incidence;
a light detector arranged to detect light reflected off of the sample of material at a plurality of angles of observation; and
an imaging device arranged to capture images of the sample of material at the plurality of angles of observation.

17. The system of claim 16, wherein the light detector includes a spectrometer configured to measure magnitudes of spectrum components of light.

18. The system of claim 16, wherein the light emitter includes at least one emitter configured to emit collimated light for reflection off of the sample of material.

19. The system of claim 16, wherein the light emitter includes at least two emitters, and wherein:
a first emitter of the at least two emitters is configured to emit collimated light; and
a second emitter of the at least two emitter is configured to emit diffuse light.

20. The system of claim 16, wherein the light emitter is coupled to the light source with one or more optical waveguides.

21. A system for determining the angular visual response of a cosmetic surface, comprising:
a support table;
a sample support member arranged on the support table and configured to support a sample of material;
a light detector arranged to travel about a first arcuate path about the sample of material;
a light source arranged proximate the support table and configured to generate light;
a light emitter in optical communication with the light source and arranged to emit the generated light and arranged to travel along a second arcuate path about the sample of material; and
an imaging device arranged to travel about a third arcuate path about the sample of material.
